(19) United States
(12) Patent Application Publication
(10) Pub. No.: US 2005/0210111 A1
(43) Pub. Date: Sep. 22, 2005

(54) E-mail server, e-mail terminal and programs

(75) Inventor: Kenji Fukudome, Kawabe-gun (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 10/924,916

(22) Filed: Aug. 25, 2004

(30) Foreign Application Priority Data
Mar. 17, 2004 (JP) 2004-076328

(51) Int. Cl. G06F 15/173; G06F 15/16

(52) U.S. Cl. 709/206; 709/224

(57) ABSTRACT

An e-mail terminal receives a URL and specification information which specifies a condition for obtaining web page data indicated by the URL, and transmits an e-mail which includes the URL and the specification information to an e-mail server. The e-mail server receives the e-mail which includes the URL and the specification information, and obtains the web page data indicated by the URL, according to the specification information. Then, the e-mail server attaches the web page data to the e-mail and transfers the e-mail to other e-mail server or e-mail terminal.

### CROSS-REFERENCE TO RELATED APPLICATIONS

This application is based on patent application No. 2004-76328 filed in Japan, the contents of which are hereby incorporated by reference.

### BACKGROUND OF THE INVENTION

(1) Field of the Invention

The present invention relates to an e-mail server, an e-mail terminal and programs, and more specifically relates to a technique for attaching specified web page data to an e-mail, and delivering the e-mail.

(2) Description of the Related Art

In recent years, WWW (World Wide Web) has become widespread, and web pages are used with various terminals, such as personal computers, mobile phones and PDAs (Personal Digital Assistant).

Generally, web pages are displayed on WWW terminals and used by a user. There is a case where the user wishes to show a web page, in which the user is particularly interested, to others. Also, there may be a case where the user needs to transfer web page data to devices such as a printer.

For the above cases, several e-mail techniques are suggested. For instance, for the former case, a technique for delivering web page data by e-mail is disclosed (Japanese Unexamined Patent Publication No. 2001-216210). For the latter case, a technique for outputting required web page data to a facsimile by transmitting an e-mail from an e-mail terminal, is disclosed (Japanese Unexamined Patent Publication No. 2001-216210).

However, web pages can be updated frequently or deleted without notice. Therefore, it is possible that delivered web page data does not contain valid information, or a web page linked from a delivered URL (Uniform Resource Locator) is already deleted.

### SUMMARY OF THE INVENTION

The object of the present invention is therefore to provide an e-mail server, an e-mail terminal and programs for more surely transferring specified web page data.

The above object is fulfilled by an e-mail server, comprising: an e-mail reception unit operable to receive an e-mail which includes a URL (Uniform Resource Locator) and specification information which specifies a condition for obtaining web page data indicated by the URL; a judging unit operable to judge whether the condition is fulfilled; a web page data obtaining unit operable to obtain the web page data in the case where the judging unit judges that the condition is fulfilled; and a web page data transmission unit operable to transmit the obtained web page data to a destination address of the e-mail.

According to the stated construction, a period for obtaining web page data specified by a URL, or a web client which is to obtain the web page data can be specified by a user. Therefore, the web page data can be transferred more surely.

The condition may include, for instance, (i) specification of a period for obtaining the web page data or (ii) specification of a web client which is to obtain the web page data, and the judging unit may judge (i) whether current time is within the period or (ii) whether the e-mail server is identical with the web client.

Also, when transmitting a web page data, the web page data transmission unit may attach the web page data to the e-mail which is received by the e-mail reception unit, and transmits the e-mail.

Also, the judging unit may perform the judgment when the e-mail reception unit receives the e-mail.

This enables the web page data, which is exactly the same data as the data to which the sender of the e-mail has referred, to be attached to the e-mail. In addition, this enables the sender to save time for operations for attaching the web page data to the e-mail.

The e-mail server may further comprise: a transmission request reception unit operable to receive a transmission request for transmitting the e-mail received by the e-mail reception unit, wherein the web page data obtaining unit obtains the web page data when the transmission request reception unit receives the transmission request.

According to the stated construction, the web page data at the time immediately before the e-mail is received by the destination e-mail terminal can be attached to the e-mail. As a result, the sender can surely have the recipient refer to up-to-data web page data. In addition, cost and time for referring the web page by the recipient him/herself can be saved compared to the case of notifying the recipient of only the URL.

The URL may be inserted in a predetermined header field of the e-mail. Also, the URL may be inserted in any of MIME parts of the e-mail.

According to the stated construction, the process for obtaining a URL from the e-mail becomes simpler, the processing load becomes lighter, and the processing speed becomes higher.

Alternatively, an e-mail server of the present invention may comprise: a destination address storage unit operable to store one or more destination addresses; an e-mail reception unit operable to receive an e-mail which includes a URL (Uniform Resource Locator); a web page data obtaining unit operable to obtain web page data indicated by the URL in the case where a destination address of the e-mail received by the e-mail reception unit is identical with any of the destination addresses stored in the destination address storage unit; and a web page data transmission unit operable to transmit the obtained web page data to the destination address of the e-mail received by the e-mail reception unit.

According to the stated construction, the transfer of the web page data specified by a URL can be assured. Also, both web page data at the time when the e-mail is received by the e-mail server, and web page data at the time when the e-mail is transmitted to the destination e-mail terminal can be attached to the one e-mail. This further assures the transfer of the web page data.

A program of the present invention instructs a computer to perform: an e-mail reception step for receiving an e-mail which includes a URL (Uniform Resource Locator) and specification information which specifies a condition for obtaining web page data indicated by the URL; a judging step for judging whether the condition is fulfilled; a web page data obtaining step for obtaining the web page data in the case where it is judged that the condition is fulfilled; and a web page data transmission step for transmitting the obtained web page data to a destination address of the e-mail.

With the stated program, the advantageous effect of the present invention can be gained by making a computer perform the processes of the above-described e-mail server.

An e-mail terminal of the present invention comprises: a URL reception unit operable to receive a URL (Uniform Resource Locator); a specification information reception unit operable to receive specification information which specifies a condition for obtaining web page data indicated by the URL; an e-mail editing unit operable to edit an e-mail so as to include the URL and the specification information in the e-mail; and a web page data transmission unit operable to transmit, to an e-mail server, the e-mail edited by the e-mail editing unit.

According to the stated construction, time for editing an e-mail which is for making the e-mail server surely transfer the specified web page data can be saved. Note that the specification information receiving unit is a concept including a functional component which receives the specification information from the user just as the timing specification reception unit, which described below, receives.

The condition may include, for instance, (i) specification of a period for obtaining the web page data or (ii) specification of a web client which is to obtain the web page data. Also, the e-mail editing unit may insert the URL in a predetermined header field of the e-mail.

According to the stated construction, the processing load for the e-mail server to extract a URL from an e-mail becomes lighter, and the processing speed becomes higher.

A program of the present invention instructs a computer to perform: a URL reception step for receiving a URL (Uniform Resource Locator); a specification information receiving step for receiving a specification information which specifies a condition for obtaining web page data indicated by the URL; an e-mail editing step for editing an e-mail so as to include the URL and the specification information in an e-mail; and an e-mail transmission step for transmitting, to an e-mail server, the e-mail edited by the e-mail editing step.

With the stated program, the advantageous effect of the present invention can be gained by making a computer perform the process of the above-described e-mail terminal.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 is a pattern diagram which shows a network configuration of an IP communication system according to the embodiment of the present invention;

FIG. 2 is a functional block diagram which shows principal functional components of an e-mail terminal 10 according to the embodiment of the present invention;

FIG. 3 is a functional block diagram which shows principal functional components of an e-mail server 13 according to the embodiment of the present invention;

FIG. 4 is a flowchart which represents the operation of the e-mail terminal 10 according to the embodiment of the present invention, especially the operation for delivering web page data;

FIG. 5 is a flowchart which represents the operations of the e-mail server 13 according to the embodiment of the present invention, especially the operations for receiving an e-mail by which web page data is transferred; and

FIG. 6 is a flowchart which represents the operation of the e-mail server 13 according to the embodiment of the present invention for transmitting an e-mail in response to a request from an e-mail terminal.

### DESCRIPTION OF THE PREFERRED EMBODIMENT

The following describes an e-mail server, an e-mail terminal and programs according to a preferred embodiment of the present invention, with reference to figures. An IP (Internet Protocol) communication system which includes the e-mail server, the e-mail terminal and the programs is taken as an example for the description.

1. The Configuration of the IP Communication System

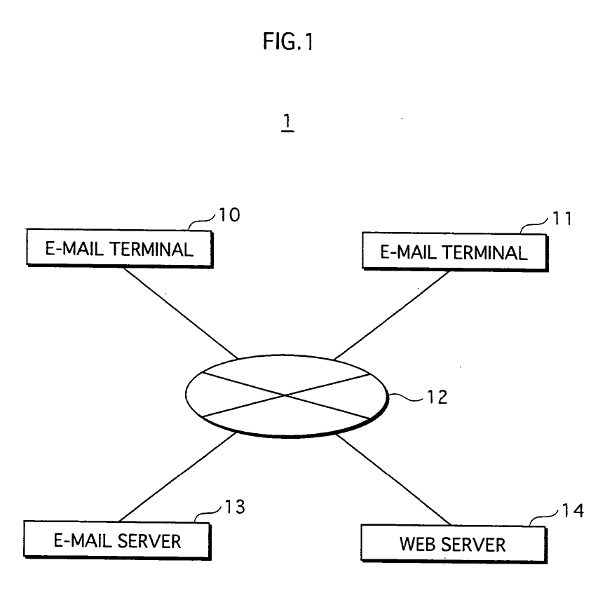

FIG. 1 is a pattern diagram which shows a network configuration of the IP communication system. As shown in FIG. 1, the IP communication system 1 includes e-mail terminals 10 and 11, an e-mail server 13, and a web server 14. These devices are interconnected to each other via a communication network 12.

The e-mail terminals 10 and 11 are personal computers or the likes, and each of them includes a mailer for transmitting and receiving e-mails, and a web browser for browsing web pages.

The e-mail server 13 is a so-called server machine or the like which provides higher performance than personal computers. The e-mail server 13 receives e-mails from other e-mail servers or e-mail terminals, and transfers e-mails to other e-mail servers according to SMTP (Simple Mail Transfer Protocol). Also, in the case where there is a predetermined description in an e-mail, the e-mail server 13 obtains web page data from the web server 14 according to the description, as described later.

The web server 14 is a so-called server machine or the like which provides higher performance than personal computers. The web server 14 provides WWW services according to HTTP (Hypertext Transfer Protocol).

The communication network 12 is a so-called IP network. As far as the present invention concerns, it does not matter whether the communication network 12 is so-called Internet or a private network. Also, it does not matter whether it is WAN (Wide Area Network) or LAN (Local Area Network).

1-1. The Configuration of the E-Mail Terminal 10

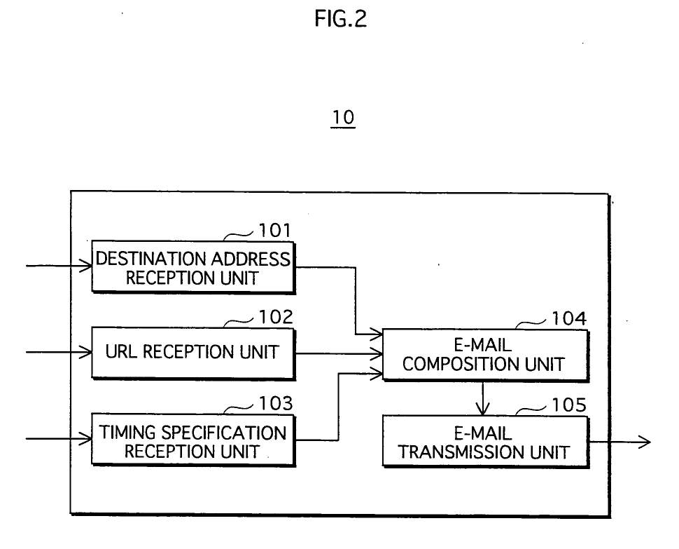

The following is a description of the functional components of the e-mail terminal 10. FIG. 2 is a functional block diagram which shows principal functional components of the e-mail terminal 10. The e-mail terminal 10 includes, as principal functional components, a destination address reception unit 101, a URL reception unit 102, a timing specification reception unit 103, an e-mail composition unit 104, and an e-mail transmission unit 105.

The destination address reception unit 101 is a functional block which receives, from a user of the e-mail terminal 10, a destination e-mail address to which web page data is to be delivered.

The URL reception unit 102 is a functional block which receives a URL of a web page which is to be delivered to the destination e-mail address. The timing specification reception unit 103 is a functional block which receives, as described later, a timing specification which specifies timing with which an e-mail server obtains web page data from the URL.

In this embodiment, the timing specification reception unit 103 receives two kinds of timing specifications, which are a timing specification “1” and a timing specification “2”. The timing specification “1” indicates that the e-mail server 13 should obtain web page data immediately after receiving the e-mail. The timing specification “2” indicates that the e-mail server 13 should obtain web page data when requested by the destination e-mail terminal to transmit the e-mail. These timing specifications may be set at the same time.

The e-mail composition unit 104 is a function block which composes an e-mail which includes the destination e-mail address, the URL, and the timing specification. The e-mail composition unit 104 composes an e-mail basically according to RFC (Request for Comment) 2822. The destination e-mail address is described in the “To” field of a mail header.

The URL is described, for instance, in the “Content-Location” field. The following is a description example of a URL:
Content-Location: http://konicaminolta.jp/

The “Content-Location” field is a header field which is defined in RFC 2076. In this field, a URL for restoring the content of an e-mail is described. The URL may be described in a non-standard field, such as “Content-Alias” field or the “X-URL” field, not in the “Content-Location” field.

In this case, the URL can be easily extracted compared to the case of extracting the URL from the body of an e-mail. As a result, the processing load of the e-mail server 13 can be lightened and the URL extraction process can become faster.

The timing specification is described, for instance, in the “Comments” field. In the case where the e-mail server 13 receives a timing specification which indicates that the e-mail server 13 should obtain web page data immediately after receiving the e-mail, the description is:

Comments: 1

In the case where the e-mail server 13 receives a timing specification which indicates that the e-mail server 13 should obtain web page data when transmitting the e-mail in response to a transmission request from an e-mail terminal, the description is:

Comments: 2

In the case where the e-mail server 13 receives both of the above-described timing specifications, the description is:

Comments: 3

The e-mail transmission unit 105 is a functional block which transmits, to an e-mail server, an e-mail which is composed by the e-mail composition unit 104. The e-mail transmission unit 105 transmits an e-mail according to SMTP.

1-2. The Configuration of the E-Mail Server 13

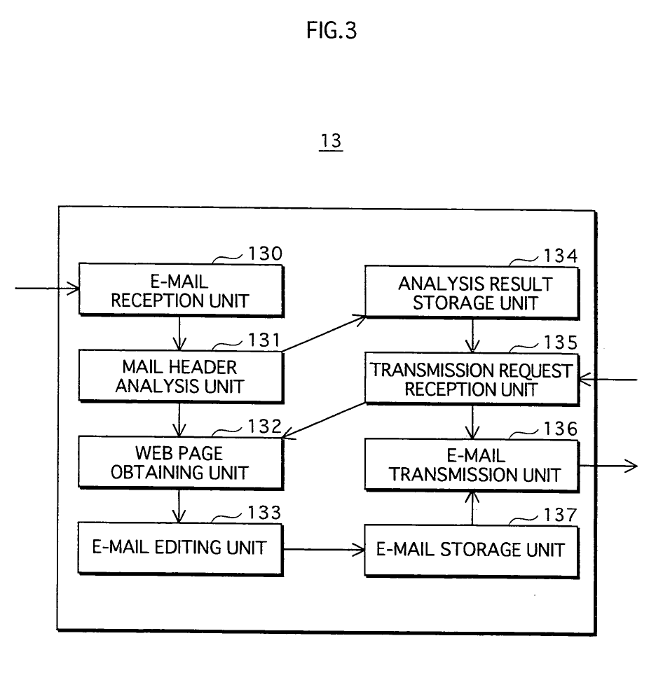

The following is a description of the functional components of the e-mail server 13. FIG. 3 is a functional block diagram which shows principal functional components of the e-mail server 13. As FIG. 3 shows, the e-mail server 13 includes an e-mail reception unit 130, a mail header analysis unit 131, a web page obtaining unit 132, an e-mail editing unit 133, an analysis result storage unit 134, a transmission request reception unit 135, an e-mail transmission unit 136, and an e-mail storage unit 137.

The e-mail reception unit 130 is a functional block which receives an e-mail from an e-mail terminal or an e-mail server other than itself, according to SMTP.

The mail header analysis unit 131 is a functional block which analyzes a header part of an e-mail which is received by the e-mail reception unit 130. The mail header analysis unit 131 judges whether the “Content-Location” field and the “Comments” field are included in the header part, and in the case where they are included, the mail header analysis unit 131 refers to the value of the timing specification in the “Comments” field.

In the case where the value is “1”, the mail header analysis unit 131 requests the web page obtaining unit 132 to obtain the web page data specified by the description in the “Content-Location” field. However, in the case where the specified web page data is included in the body of the received e-mail, the mail header analysis unit 131 does not make the request. This is because in the case where other e-mail server has already obtained the web page data, the obtained data should be considered as valid data.

In the case where the value is “2”, the analysis result, which indicates that the web page data should be obtained, is stored in the analysis result storage unit 134 when the e-mail is transmitted.

In the case where the value is “3”, the mail header analysis unit 131 requests the web page obtaining unit 132 to obtain the web page data specified by the description in the “Content-Location” field. Also, the analysis result, which indicates that the web page data should be obtained, is stored in the analysis result storage unit 134 when the e-mail is transmitted.

The web page obtaining unit 132 obtains web page data, in response to a request from the mail header analysis unit 131 or the transmission request reception unit 135, according to HTTP. The web page obtaining unit 132 transfers the obtained web page data to the e-mail editing unit 133.

When receiving the web page data from the web page obtaining unit 132, the web page editing unit 133 attaches the web page data to the body of the e-mail received by the e-mail reception unit 130. Here, the e-mail editing unit 133 adds the web page data to the body of the e-mail according to MIME (Multipurpose Internet Mail Extensions, RFC 2045, RFC 2046, and RFC 2047). The e-mail storage unit 137 stores the e-mail edited by the e-mail editing unit 133.

The analysis result storage unit 134 is a functional block which receives and stores the analysis result transferred from the mail header analysis unit 131. The analysis result is referred in response to the request from the transmission request reception unit 135, and to be deleted.

The transmission request reception unit 135 is a functional block which receives a request from an e-mail terminal to transmit an e-mail. When receiving the transmission request, the transmission request reception unit 135 refers to the analysis result stored in the analysis result storage unit 134 for checking the timing specification of the e-mail which is to be transmitted.

In the case where the timing specification is “2” or “3”, the transmission request reception unit 135 requests the web page obtaining unit 136 to obtain the indicated web page data. Also, the transmission request reception unit 135 requests the e-mail transmission unit 136 to transmit the e-mail related to the request. Then the transmission request reception unit 135 requests the analysis result storage unit 134 to delete the analysis result after responding to all the preceding requests.

The e-mail transmission unit 136 is a functional block which reads and transmits an e-mail stored in the e-mail storage unit 137 to an e-mail terminal in response to a request from the transmission request reception unit 135. After reading an e-mail, the e-mail transmission unit 136 requests the e-mail storage unit 137 to delete the e-mail.

The e-mail storage unit 137 is a functional block which receives and stores an e-mail from the e-mail editing unit 133. The e-mail storage unit 137 deletes a stored e-mail in response to the request from the e-mail transmission unit 136. Note that the e-mail storage unit may be a so-called mailbox. In other words, the e-mail storage unit 137 may store e-mails which are not edited by the e-mail editing unit 133. Also, the e-mail storage unit 137 may classify and store e-mails according to the destination address of each e-mail.

2. Operations

The following is a description of the operations of the e-mail terminal 10 and the e-mail server 13, which are included in the IP communication system 1.

2-1. The Operation of the E-Mail Terminal 10

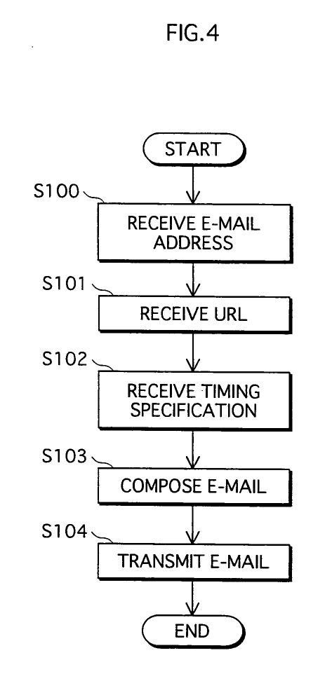

FIG. 4 is a flowchart which represents the operation of the e-mail terminal 10, especially the operation for delivering web page data. Firstly, by the destination address reception unit 101, the e-mail terminal 10 receives, from a user of the e-mail terminal 10, a destination e-mail address to which web page data is transmitted as FIG. 4 shows (step S100). Then, the e-mail terminal 10 receives, by the URL reception unit 102, the URL of the web page data which is to be transmitted (step S101), and receives, by the timing specification reception unit 103, the timing specification which indicates the timing with which the web page data should be obtained (step S102).

After receiving the e-mail address, the URL, and the timing specification, the e-mail terminal 10 composes, by the e-mail composition unit 104, an e-mail in which these pieces of information are described (step S103). Finally, the e-mail terminal 10 transmits the e-mail by the e-mail transmission unit 105 (step S104). Note that when composing an e-mail, the e-mail terminal 10 may receive descriptions in the header field, such as the “subject” field, or descriptions in the body part.

2-2. The Operations of the E-Mail Server 13

The following is a description of the operations of the e-mail server 13 for receiving an e-mail and transmitting an e-mail.

(1) Operations for Receiving an E-Mail

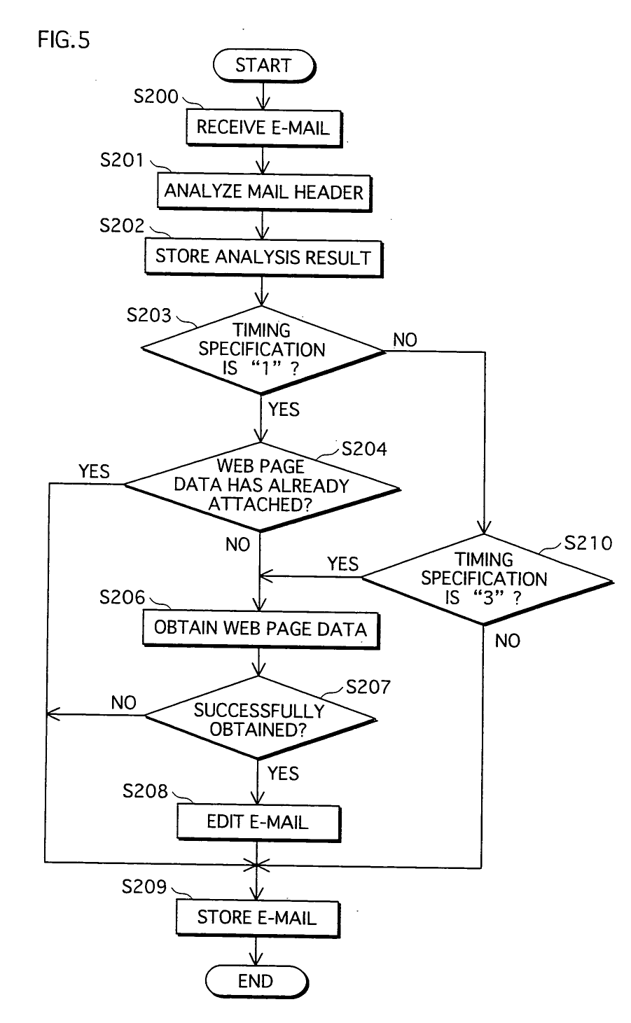

FIG. 5 is a flowchart which represents the operation of the e-mail server 13, especially the operations for receiving an e-mail by which web page data is transferred. As FIG. 5 shows, the e-mail server 13 receives an e-mail by the e-mail reception unit 130 (step S200), analyzes the mail header of the e-mail by the mail header analysis unit 131 (step S201), and stores the analysis result in the analysis result storage unit 134 (step S202).

Then, in the case where the timing specification described in the header field “Comments” is “1” (“YES” in step S203), the e-mail server 13 checks whether the web page data linked from the URL described in the “Content-Location” field is attached to the body of the e-mail. When the web page data is not attached to the body (“NO” in step S204), the e-mail server 13 tries to obtain the web page data by the web page obtaining unit 132 (step S206). When the web page data is successfully obtained (“YES” in step S207), the e-mail server 13 attaches the obtained data to the e-mail by the e-mail editing unit 133 (step S208).

Also, in the case where the timing specification is not “1” (“NO” in step S203), but “3” (“YES” in step S210), the e-mail server 13 tries to obtain the web page data (step S206). When the web page data is successfully obtained (“YES” in step S207), the e-mail server 13 attaches the obtained data to the e-mail (step S208).

The e-mail server 13 stores the e-mail in the e-mail storage unit 137 (step S209) and finishes the process in the following cases:
the case where the web page data has already attached to the body of the e-mail (“YES” in step S204);
the case where the web page data obtaining unit fails to obtain the web page data (“NO” in step S207);
the case where the timing specification is neither “1” nor “3” (“NO” in step S210); and
the case where the e-mail server finishes editing the e-mail.

Usually, an e-mail is delivered to the destination e-mail terminal via a plurality of e-mail servers. By the above-described operations, in the case where the timing specification is “1”, web page data is attached to an e-mail by the e-mail server that receives the e-mail first. As a result, the web page data at the time immediately after the sender specifies the URL is attached to the e-mail. Therefore, this is of benefit when the sender wishes to avoid the case where the web page data is updated or deleted during the period between the time at which the URL is specified and the time at which the web page data is attached.

In the case where the timing specification is “2”, the web page data is attached by the e-mail server that receives a transmission request from the destination e-mail terminal. As a result, the web page data at the time immediately before the e-mail arrives at the destination e-mail terminal is attached to the e-mail. Therefore, this is of benefit when the sender wishes to send up-to-date information which changes from one minute to the next, such as of stock prices, the weather, and news. Also in the case where the sender wishes to send a direct e-mail which notifies the recipient of the newest products information or services for a limited time, appropriate information can be sent to the recipient regardless of how often the recipient accesses the e-mail server.

In the case where the timing specification is “3”, all the e-mail servers, which the e-mail goes through, try to attach the web page data to the e-mail. As a result, a problem, such as a failure to attach the web page data because of a malfunction of a web server, occurs less frequently. Also, the web page data is attachable as long as the e-mail goes through at least one e-mail server according to the embodiment. Therefore, the embodiment ensures the transfer of web page data.

(2) Operations for Transmitting an E-Mail

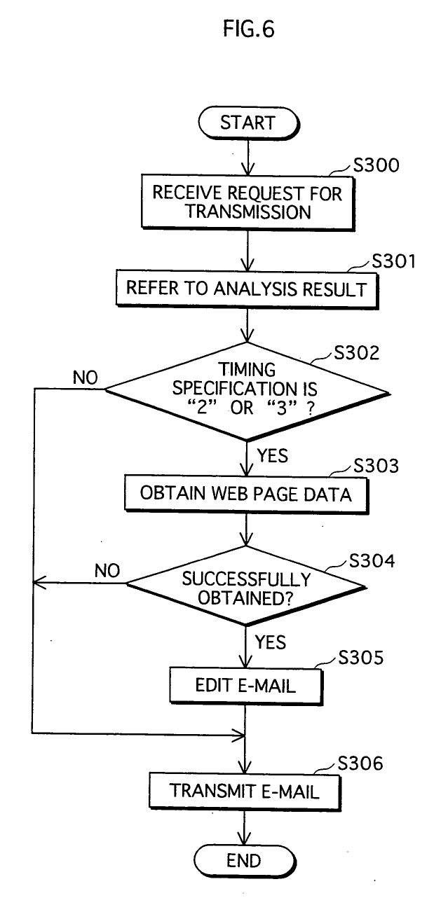

FIG. 6 is a flowchart which represents the operation of the e-mail server 13 for transmitting an e-mail in response to a request from an e-mail terminal. As FIG. 6 shows, the e-mail server 13 receives, by transmission request reception unit 135, a request for transmitting an e-mail (step S300), and refers to the analysis result data, which relates to the e-mail and stored in the analysis result storage unit 134 (step S301).

Then, in the case where the timing specification relating to the analysis result is “2” or “3” (“YES” in step S302), the e-mail server 13 tries to obtain the web page data by the web page obtaining unit 132 (step S303). When the web page data is successfully obtained (“YES” in step S304), the e-mail server 13 attaches the obtained data to the body of the indicated e-mail (step S305).

The e-mail server 13 transmits the e-mail to the e-mail terminal which has made the request and finishes the process in the following cases:
the case where the timing specification is “1” (“NO” in step S302);
the case where web page data obtaining unit fails to obtain the web page data (“NO” in step S304); and
the case where the e-mail server 13 finishes editing the e-mail.
   (3) Other Operations

Other than the above-described operations, the e-mail server 13 transmits an e-mail to other e-mail servers according to SMTP. In this case, the e-mail server 13 may try to obtain web page data. This increases opportunities of obtaining web page data, and web page data is to be attached to an e-mail more certainly.

On the contrary, the e-mail server 13 may not try to obtain web page data in that case. This lightens the processing load of the e-mail server for obtaining web page data.

3. Modifications

The present invention is described above based on the preferred embodiment, however, the present invention is not limited to the embodiment as a matter of cause, and the following modifications may be performed.

(1) In the above-described embodiment, the timing of transmission and reception of an e-mail by the e-mail server is specified by the timing specification. However, the present invention is not limited to this as a matter of course.

The time at which the web page data is to be attached may be used as the timing specification. This is of benefit in the case where a sender wishes to notify a recipient of stock prices at certain time, for instance. Also, web page data may be obtained at various moments, and all pieces of the obtained data may be attached to an e-mail at the same time. By this operation, the change of the web page data from one minute to the next is to be recorded as attached data of an e-mail, and the recipient can compare those pieces of the data with each other.

(2) In the above-described embodiment, the present invention is described with naming specific header fields, such as the “Content-Location” field and “Comments” field, however, the present invention is not limited to these header fields as a matter of course, and other header fields, such as “Subject” field, which may not be based on the standard, may be used.

Any header field is used to gain the advantage of the present invention as long as an e-mail terminal which transmits an e-mail can specify the values of the header field, and as long as an e-mail server which transfers the e-mail can refer the header field for performing the above-described operation.

(3) The e-mail server may attach web page data to an e-mail in the form of a HTML mail which displays the web page data as it is, although this operation is not referred in the embodiment. Also, the e-mail server may attach web page data to an e-mail in a compressed form, and show the data after extraction when the data is received by a recipient.

Also, the number of web pages whose data is to be attached to an e-mail is not limited to one. Data of plurality of web pages may be attached to an e-mail. The advantage of the present invention does not change regardless of the format of attached web page data.

(4) The timing specification may be specified in the following manner, although this is not referred in the above-described embodiment:
To arrange two choices, for instance, such as “Transmit an e-mail with setting the URL in the Subject field” and “Transmit an e-mail with setting the URL in the Attachment part” in a button menu which is displayed by clicking a mouse on a web browser;
In the case where the choice “Transmit an e-mail with setting the URL in the Subject field” is taken, to start up the mailer and make the user edit an e-mail, the “Subject” field in the mail header of which is filled with the URL of the web page which is displayed by the web browser when the choice is taken; and
In the case where the choice “Transmit an e-mail with setting the URL in the Attachment part” is taken, to start up the mailer and make the user edit an e-mail, the “attachment part” of which is filled with the URL of the web page which is displayed by the web browser when the choice is taken.

Here, “setting the URL in the Attachment part” means attaching the URL to a part of MIME parts in the body of an e-mail, according to MIME standard. The URL may be inserted, for instance, in the “Content-Description” field of the MIME header. This lightens the processing load for extracting the URL from the “attachment part”, and the processing speed becomes higher.

Also, instead of the above-described operations, the URL may be added to the “attachment part” by dragging and dropping a URL icon on the web browser.

(5) In the above-described embodiment, the e-mail server refers to the timing specification included in an e-mail in order to obtain data in the web server, however, instead of this operation, or adding to this operation, the following operation may be performed:

The e-mail server previously stores a list of e-mail addresses, and the e-mail server obtains web page data when the e-mail server receives an e-mail whose destination e-mail address is on the list, or when the e-mail server is requested by the e-mail terminal to transmit such an e-mail.

The same effect as the timing specification “3” described in the above embodiment can be achieved by this operation.

(6) In the above embodiment, the e-mail server and the e-mail terminal are mainly described, however, the present invention is not limited to this as a matter of course, and the effect of the present invention is achievable with programs which instruct a computer to perform the above-described processes. Also, the present invention may be a method which is performed by a computer with use of such programs, or a storage medium which stores such programs. In any of those cases, the effect of the invention is achievable.

(7) In the above-described embodiment, the web page data is obtained according to the timing specification, however, the present invention is not limited to this as a matter of course, and the web page data may be obtained in the following manner:

In the mail system including a STMP server and a POP3 (Post Office Protocol version 3) server, web page data may be obtained according to a location specification which specifies one of the SMTP server and the POP3 server or both of them, instead of the timing specification, or adding to the timing specification. The location specification may be received from a user through an e-mail terminal.

The SMTP server and the POP3 server obtain the web page data indicated by the URL inserted in the header field, according to the location specification, and attach the data to an e-mail. Note that in the case where the POP3 server is specified by the location specification, the POP3 server may obtain the web page data when receiving a transmission request for the e-mail from an e-mail terminal, and may attach the web page data to the e-mail which is to be transmitted.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. An e-mail server, comprising:
an e-mail reception unit operable to receive an e-mail which includes a URL (Uniform Resource Locator) and specification information which specifies a condition for obtaining web page data indicated by the URL;
a judging unit operable to judge whether the condition is fulfilled;
a web page data obtaining unit operable to obtain the web page data in the case where the judging unit judges that the condition is fulfilled; and
a web page data transmission unit operable to transmit the obtained web page data to a destination address of the e-mail.

2. The e-mail server of claim 1, wherein
the condition includes (i) specification of a period for obtaining the web page data or (ii) specification of a web client which is to obtain the web page data, and
the judging unit judges (i) whether current time is within the period or (ii) whether the e-mail server is identical with the web client.

3. The e-mail server of claim 1, wherein
the web page data transmission unit attaches the web page data to the e-mail which is received by the e-mail reception unit, and transmits the e-mail.

4. The e-mail server of claim 1, wherein
the judging unit performs the judgment when the e-mail reception unit receives the e-mail.

5. The e-mail server of claim 1, further comprising:
a transmission request reception unit operable to receive a transmission request for transmitting the e-mail received by the e-mail reception unit, wherein
the web page data obtaining unit obtains the web page data when the transmission request reception unit receives the transmission request.

6. The e-mail server of claim 1, wherein
the URL is inserted in a predetermined header field of the e-mail.

7. The e-mail server of claim 1, wherein
the URL is inserted in any of MIME parts of the e-mail.

8. An e-mail server, comprising:
a destination address storage unit operable to store one or more destination addresses;
an e-mail reception unit operable to receive an e-mail which includes a URL (Uniform Resource Locator);
a web page data obtaining unit operable to obtain web page data indicated by the URL in the case where a destination address of the e-mail received by the e-mail reception unit is identical with any of the destination addresses stored in the destination address storage unit; and
a web page data transmission unit operable to transmit the obtained web page data to the destination address of the e-mail received by the e-mail reception unit.

9. A program which instructs a computer to perform:
an e-mail reception step for receiving an e-mail which includes a URL (Uniform Resource Locator) and specification information which specifies a condition for obtaining web page data indicated by the URL;
a judging step for judging whether the condition is fulfilled;
a web page data obtaining step for obtaining the web page data in the case where it is judged that the condition is fulfilled; and
a web page data transmission step for transmitting the obtained web page data to a destination address of the e-mail.

10. An e-mail terminal, comprising:
a URL reception unit operable to receive a URL (Uniform Resource Locator);
a specification information reception unit operable to receive specification information which specifies a condition for obtaining web page data indicated by the URL;
an e-mail editing unit operable to edit an e-mail so as to include the URL and the specification information in the e-mail; and
a web page data transmission unit operable to transmit, to an e-mail server, the e-mail edited by the e-mail editing unit.

11. The e-mail terminal of claim 10, wherein
the condition includes (i) specification of a period for obtaining the web page data or (ii) specification of a web client which is to obtain the web page data.

12. The e-mail terminal of claim 10, wherein
the e-mail editing unit inserts the URL in a predetermined header field of the e-mail.

13. A program which instructs a computer to perform:
a URL reception step for receiving a URL (Uniform Resource Locator);
a specification information receiving step for receiving a specification information which specifies a condition for obtaining web page data indicated by the URL;
an e-mail editing step for editing an e-mail so as to include the URL and the specification information in an e-mail; and
an e-mail transmission step for transmitting, to an e-mail server, the e-mail edited by the e-mail editing step.
